(19) United States
(12) Patent Application Publication
(10) Pub. No.: US 2020/0044200 A1
(43) Pub. Date: Feb. 6, 2020

(54) Energy Cell Holding Device for a Motor Vehicle

(71) Applicant: CPT Group GmbH, Hannover (DE)

(72) Inventors: Markus Ochs, Frankfurt / Main (DE); Henry Strobel, Sulzbach (DE); Paul-Markus Schweizer-Berberich, Berlin (DE)

(73) Assignee: CPT Group GmbH, Hannover (DE)

(21) Appl. No.: 16/337,732

(22) PCT Filed: Sep. 5, 2017
(86) PCT No.: PCT/EP2017/072263

§ 371 Date: Mar. 28, 2019

(30) Foreign Application Priority Data
Oct. 5, 2016 (DE) 10 2016 219 302.3

(51) Int. Cl. H01M 2/02; B60K 6/28; B60L 50/64; B60L 50/60

(52) U.S. Cl. CPC H01M 2/022; B60L 50/66; B60L 50/64; B60K 6/28

(57) ABSTRACT

Various embodiments include an energy cell holding device for a motor vehicle comprising: a contact plate having a cutout and an overhang. The cutout and the overhang fix the energy cell to the contact plate via a casing surface of the energy cell by form fit and/or force fit and/or substance bonding. The cutout and the overhang contact an electrical terminal of the energy cell via the casing surface of the energy cell.

### CROSS-REFERENCE TO RELATED APPLICATIONS

This application is a U.S. National Stage Application of International Application No. PCT/EP2017/072263 filed Sep. 5, 2017, which designates the United States of America, and claims priority to DE Application No. 10 2016 219 302.3 filed Oct. 5, 2016, the contents of which are hereby incorporated by reference in their entirety.

### TECHNICAL FIELD

The present disclosure relates to motor vehicles. Various embodiments of the teachings herein may include an energy cell holding device and/or an energy cell module for motor vehicles.

### BACKGROUND

DE 10 2014 216811 A1 describes a battery module system comprising a housing for receiving at least two battery modules, wherein the housing has connecting elements on an inside to receive connecting elements of the battery modules in order to fix the battery modules in the housing, wherein the battery modules each have an end plate on which the connecting elements of the battery module are arranged.

### SUMMARY

The teachings of the present disclosure describe various systems including an improved structure of modules and systems for battery cells for motor vehicles. For example, some embodiments include an energy cell holding device (10) for a motor vehicle, comprising: a contact plate (1) which has at least one cutout (4-n) and at least one overhang (2-n); wherein the cutout (4-n) and the overhang (2-n) are designed to fix the energy cell (5) to the contact plate (1) via a casing surface of the energy cell (5) by form fit and/or force fit and/or substance bonding; and wherein the cutout (4-n) and the overhang (2-n) are designed to contact at least one electrical terminal of the energy cell (5) via the casing surface of the energy cell (5).

In some embodiments, the cutout (4-n) and the overhang (2-n) are designed to fix the energy cell (5) to the contact plate (1) via the casing surface of the energy cell (5) by form fit and/or force fit and/or substance bonding all around the casing surface.

In some embodiments, the cutout (4-n) and/or the overhang (2-n) are designed to fix the energy cell (5) by form fit and force fit in a press-fit process.

In some embodiments, the cutout (4-n) and/or the overhang (2-n) are designed to fix the energy cell (5) by substance bonding in a gluing, soldering or welding process.

In some embodiments, the cutout (4-n) and the overhang (2-n) are designed to contact the casing surface of the energy cell (5) inside a half-side region (B) of the energy cell (5) and furthermore to make a contact on the end face of the energy cell (5) inside the half-side region (B).

In some embodiments, the contact plate (1) furthermore comprises an isolating layer (6) which is designed to protect the energy cell holding device (10) against corrosion.

As another example, some embodiments include a cell module structure for a motor vehicle, wherein the cell module structure comprises at least one energy cell (5) and an energy cell holding device (10) as claimed in any of the preceding claims.

In some embodiments, the energy cell (5) has a cylindrical form or a round cell form.

In some embodiments, the energy cell (5) comprises a contact on an end face of the energy cell (5) as a first electrical contact and a contact on a casing surface as a second electrical contact, wherein the second electrical contact is arranged inside a half-side region (B), and furthermore the first electrical contact is arranged inside the half-side region (B).

In some embodiments, a casing surface of the energy cell (5) is designed to be fixed to a contact plate (1) of the energy cell holding device by form fit and/or force fit and/or substance bonding.

### BRIEF DESCRIPTION OF THE DRAWINGS

The appended drawings are intended to convey further understanding of the embodiments of the teachings of the present disclosure. The appended drawings illustrate embodiments and serve, in conjunction with the description, to clarify concepts of the teachings. Other embodiments and many of the specified advantages become apparent in relation to the figures of the drawings. The illustrated elements of the figures of the drawings are not necessarily shown true to scale with respect to one another. The drawings show:

FIG. 1 a schematic illustration of a battery cell contacting;

FIG. 2 a schematic illustration of an energy cell holding device with a battery cell contacting incorporating teachings of the present disclosure;

FIG. 3 a schematic illustration of an energy cell holding device with a battery cell contacting incorporating teachings of the present disclosure; and

FIG. 4 a schematic illustration of a contact plate of the energy cell holding device incorporating teachings of the present disclosure.

### DETAILED DESCRIPTION

Some embodiments include an energy cell holding device for a motor vehicle, comprising: a contact plate which has at least one cutout and at least one overhang; wherein the cutout and the overhang are designed to fix the energy cell to the contact plate via a casing surface of the energy cell by form fit and/or force fit and/or substance bonding; and wherein the cutout and the overhang are designed to contact at least one electrical terminal of the energy cell via the casing surface of the energy cell. In some embodiments, the energy cell is coupled or locked or fixed to the contact plate via a casing surface of the energy cell:
i) by form fit and force fit in a press-fit process; and/or
ii) by substance bonding in a gluing, soldering or welding process.

In some embodiments, the energy cell is fixed to the contact plate via a casing surface of the energy cell:
i) by form fit and force fit; and/or
ii) by substance bonding.

In some embodiments, the energy cell is mechanically connected to the contact plate along the casing surface of the energy cell. In some embodiments, there is a method for contacting round battery cells with simultaneous module sealing.

In some embodiments, a metallic, electrically conductive plate may be provided which has an overhang, generated for example by punching, on the edge of a round opening or opening adapted to the geometry of the cylindrical energy cell. In some embodiments, the overhang improves the locking and electrical contacting of the energy cell since the length or area of the contact with the energy cell, i.e. the contact or holding surface, is enlarged.

In some embodiments, the plate is guided over the cylindrical casing surface of the cell in the contacting process and fixed there.

In some embodiments, contacting on the cylindrical casing surface may take place in the same upper region of the cell which also has a cap contact on the end face. In some embodiments, the lower region of the cell does not require any electrical contact or mechanical fixing connection; the entire installation space is available for cooling, i.e. a coolant can flow completely around one half-side of the cell. The fixing takes place for example using a form-fit and force-fit connecting process. This may be a press-fit process which stamps the overhang on the casing surface of the energy cell in a form-fit and force-fit manner.

Gluing, soldering, and/or welding processes may allow a substance-bonded connection which is even sealed against liquid media such as a coolant. In some embodiments, after fixing, the casing surface of the cell and the lower side of the contact plate, for example the side facing the coolant, are provided with a coating which suppresses the electrical conductivity and at the same time protects the exposed materials from corrosion.

Because the e.g. negative first pole of the cylindrical energy cell is contacted via the casing surface in the upper region of the cylinder form via a sealed or mechanical connection, i.e. by force fit and form fit, advantageously also by substance bonding, there is no need for a further seal to protect the casing surface lying underneath from conductive media.

In some embodiments, the energy cell, with the contacts at the top and the lower casing surface—which may be freely accessible—at the bottom, is placed in a container containing a thermally conductive medium. Because of this solution or this contact arrangement, the thermal contact area of the energy cell is very large, for example over 80% of the installation space is freely accessible to the coolant, and at the same time no further seal need be provided to isolate the positive and negative contacts.

In some embodiments, a unilateral contacting of both battery poles is provided. In other words, only at most a half-side of the battery cell is used for the electrical contacting and mechanical fixing. The result is a huge cooling capacity since the coolant can flow fully around the unused half-side.

In some embodiments, a sealed connection by force fit and form fit or substance bonding is provided around the cylindrical casing surface in order to separate the contacting and locking of the battery cell from the cooling, and prevent a passage of coolant for example into the region of electrical contacts. In some embodiments, a mechanical connection between the contact plate and the casing surface of the energy cell is provided around the entire circumference of the circular contact area between the energy cell and the contact plate.

In some embodiments, an opening adapted to the energy cell is made in a contact plate, e.g. by punching.

In some embodiments, an overhang is provided which protrudes over the contact plate, for example in the direction of the positive pole, and allows a force-fit or substance-bonded connection, for example by means of laser welding, without damaging the energy cell.

In some embodiments, the two battery contacts are sealed against the cooling medium by a form-fit and/or substance-bonded connection.

In some embodiments, the cutout and the overhang are designed to fix the energy cell to the contact plate via the casing surface of the energy cell by form fit and/or force fit and/or substance bonding all around the casing surface. Here, the cooling of the battery cell may take place on the opposite side to the locking and contacting.

In some embodiments, it is provided that the cutout and/or the overhang are designed to fix the energy cell by form fit and force fit in a press-fit process. This may allow a favorable production of the battery cell holding device.

In some embodiments, it is provided that the cutout and/or the overhang are designed to fix the energy cell by substance bonding using a gluing, soldering or welding process. This may allow the provision of a sealed substance-bonded connection and a separation between regions for cooling and regions for contacting and locking.

In some embodiments, the cutout and the overhang are designed to contact the casing surface of the energy cell inside a half-side region of the energy cell, and furthermore to make a contact on the end face of the energy cell inside the half-side region. In other words, the contacting of the energy cell may take place inside a—i.e. one and the same—half-side region of the energy cell.

In some embodiments, the contact plate furthermore comprises an isolating layer which is designed to protect the energy cell holding device against corrosion.

In some embodiments, a cell module structure for a motor vehicle is provided, wherein the cell module structure comprises at least one energy cell and an energy cell holding device.

In some embodiments, the energy cell has for example a cylindrical form or a round cell form.

In some embodiments, the energy cell comprises a contact on an end face of the energy cell as a first electrical contact, and a contact on a casing surface as a second electrical contact, wherein the second electrical contact is arranged inside a half-side region, and furthermore the first electrical contact is arranged inside the half-side region. Here, the terms “first” and “second” electrical contact designate for example the negative and positive poles of the energy cell.

In some embodiments, there is a separation between the electrical contacting of the energy cell in one half-side region of the energy cell and the cooling of the energy cell in another half-side region of the energy cell.

In some embodiments, a casing surface of the energy cell is designed to be fixed to a contact plate of the energy cell holding device by form fit and/or force fit and/or substance bonding.

The described embodiments and developments can be combined with one another as desired. Further possible embodiments, developments, and implementations of the teachings of the present disclosure also comprise combinations, which have not been explicitly specified, of features of the present invention which are described above or below with respect to the exemplary embodiments. In the figures of the drawings, identical reference symbols denote identical or functionally identical elements, assemblies, components or method steps, unless specified otherwise.

The vehicle may for example be a motor vehicle or a hybrid motor vehicle such as a car, a bus or a truck, but also a rail vehicle, a ship, or an aircraft such as a helicopter or aeroplane, or a moped, a scooter, a motorcycle, a pedelec or an electric bicycle, or an eBike.

The appended drawings are intended to convey further understanding of the embodiments of the present invention. The appended drawings illustrate embodiments and serve, in conjunction with the description, to clarify concepts of the present invention.

Other embodiments and many of the specified advantages become apparent in relation to the figures of the drawings. The illustrated elements of the figures of the drawings are not necessarily shown true to scale with respect to one another. The term “energy cell” or “battery cell” as used in the present disclosure describes an energy store for electrical energy; in particular, the term includes electrochemical energy stores which may be divided into primary and secondary cells. In some embodiments, the energy cell holding device may also be used for stationary energy stores.

The term “overhang” as used in the present disclosure describes an addition of material, for example a stamping or protuberance. In some embodiments, an overhang may also for example be “left over” from punching the cutout in the contact plate or be stamped by the punching process.

The term “casing surface” as used in the present disclosure describes for example a surface or surface strip on the outside of the energy cell which for example has a cylindrical form or round cell form.

The term “end face” as used in the present disclosure describes for example a base face of the cylindrical form of the energy cell.

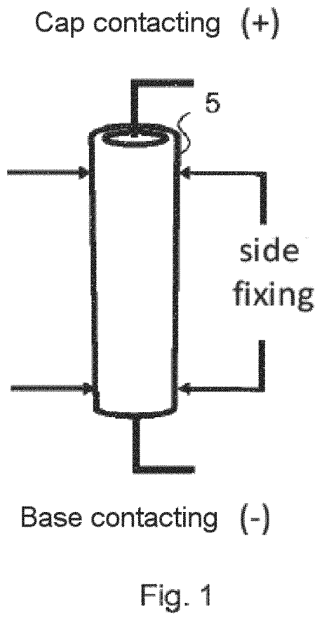

FIG. 1 shows a schematic illustration of a battery cell contacting. The battery cell 5 or energy cell 5 is contacted at the top and bottom for example by cap and base contacts on the two end faces or base faces of the round cell. A side fixing or mechanical locking may take place on the casing surface of the energy cell 5 at the points or areas of the energy cell 5 which are indicated by the arrow.

Cylindrical battery cells, for example lithium-ion batteries, are typically contacted at the positive pole (cathode) on the top and at the negative pole (anode) on the underside of the cells, wherein the cap and base of the cylinder serve as contacts. Because of the limited holding force, the electrical contacting at the cap and base of the cylindrical energy cell is not sufficient to hold the cell permanently in position, in particular for mobile applications. Here, further lateral fixings of the cell are required, as shown in FIG. 1. Also, the thermal contacting in this fashion is sometimes not sufficient for heavily loaded batteries.

In order to dissipate the waste heat from the cells, a thermal contact may be created for example via the side walls of the cylinder of the round cell. If the cell is placed in a cooling medium which is usually electrically conductive, the cap and base contacts must be sealed against the medium by seals. This entails a great complexity.

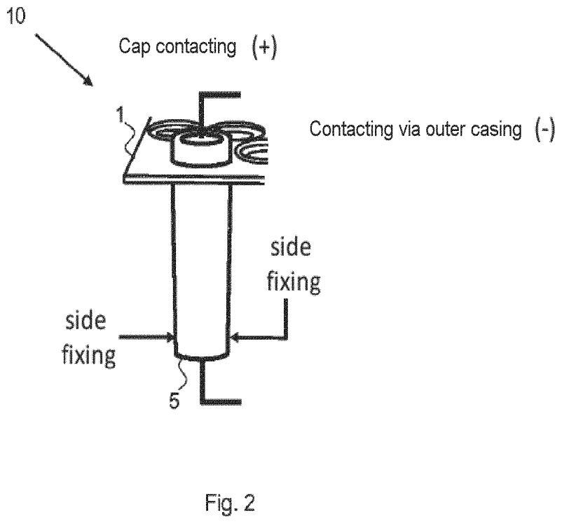

FIG. 2 shows a schematic illustration of an energy cell holding device with a battery cell contacting incorporating teachings of the present disclosure. The cap contacts of the battery cell or energy cell 5 are arranged for example at the top as shown, wherein for example the positive pole of the battery is arranged on the end face of the energy cell 5, as indicated in the drawing. Contacting via the outer casing of the energy cell 5 takes place via the contact plate 1, which has at least one cutout 4-n and at least one overhang 2-n, wherein n designates the number of the energy cells 5 in the contact plate 1. Accordingly, the contact plate 1 may comprise a plurality of cutouts 4-n and overhangs 2-n.

For example, the negative pole of the energy cell 5 is electrically connected via the contacting of the casing surface of the energy cell 5. In some embodiments, the energy cell holding device 10 allows an electrical contacting of battery cells with simultaneous, i.e. direct, cooling of the cell casing surfaces with coolant, without using rubber seals or similar complex stampings with critical tolerances.

In some embodiments, the contact plate 1 of the energy cell holding device 10 allows several energy cells 5 to be connected electrically into a module, also known in some cases as a “pack”. In some embodiments, the energy cell holding device 10 allows a block structure and a modular structure of the energy cells 5 to be achieved.

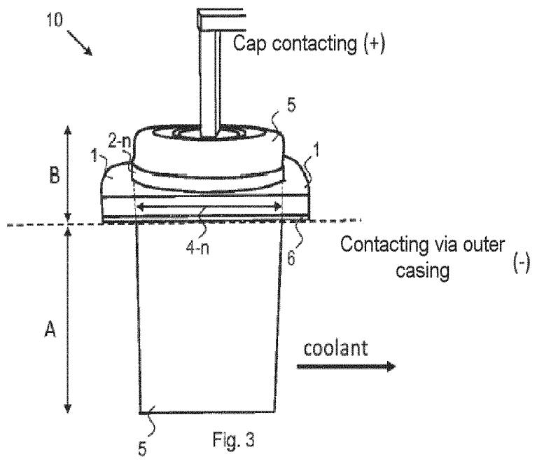

FIG. 3 shows a schematic illustration of an energy cell holding device with a battery cell contacting incorporating teachings of the present disclosure. In some embodiments, the contact plate 1 has at least one overhang 2-n which enlarges the area of contact or connection to the casing surface of the energy cell 5, and thereby improves the mechanical locking of the energy cell 5 in the energy cell holding device 10, and/or the electrical contacting of the energy cell 5 with the contact plate 1.

The energy cell 5 may be divided into a first or upper half-side region B and a second or lower half-side region A. The division of the half-side regions A, B may here be made in any arbitrary ratio. In some embodiments, the half-side region A is larger since this increases the cooling power of the cooling system. This may allow the energy cells 5 to be kept within a predefined temperature range on temperature changes caused for example by operation of the energy cells 5, or in unfavourable climatic ambient temperatures.

In some embodiments, the electrical contacting of the energy cell 5 takes place firstly by the cap contact provided on the end face in the half-side region B, and secondly by the contacting of the energy cell 5 via the casing surface, also in the half-side region B, wherein an electrical contact on the casing surface of the energy cell 5 is connected to the contact plate 1 and to the respective overhang 2-n. As indicated by an arrow, coolant can flow around the energy cell 5 in the half-side region A of the energy cell 5 and ensure corresponding cooling or tempering of the energy cell 5.

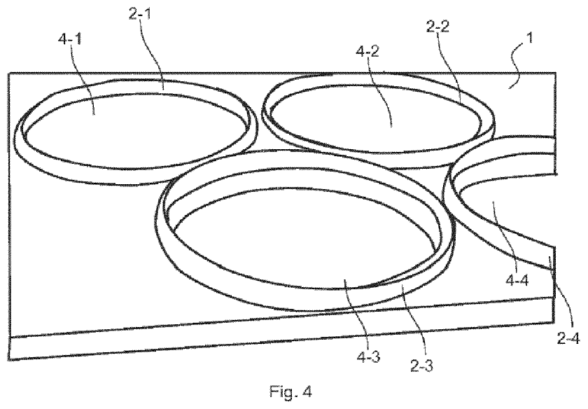

FIG. 4 shows a schematic illustration of a contact plate of the energy cell holding device incorporating teachings of the present disclosure. The contact plate 1 comprises a plurality n of cutouts 4-n and overhangs 2-n. An overhang may be provided as a stamping or protuberance, and serves to enlarge the area of connection to the casing surface of the energy cell 5. The contact plate 1, as shown in FIG. 4, here comprises four cutouts 4-1, 4-2, 4-3, 4-4 and four overhangs 2-1, 2-2, 2-3, 2-4.

Although the present teachings have been described above on the basis of exemplary embodiments, they are not limited thereto but rather can be modified in a variety of ways. In addition, it is to be noted that “comprising” and “having” do not exclude any other elements or steps, and “a” or “an” does not exclude a plurality. In addition, it is to be noted that features or steps which have been described with reference to one of the above exemplary embodiments may also be used in combination with other features or steps of other exemplary embodiments described above. Reference symbols in the claims are not to be considered to be limiting.

What is claimed is:

1. An energy cell holding device for a motor vehicle, the device comprising:
a contact plate having a cutout and an overhang;
wherein the cutout and the overhang fix the energy cell to the contact plate via a casing surface of the energy cell by form fit and/or force fit and/or substance bonding; and
wherein the cutout and the overhang contact an electrical terminal of the energy cell via the casing surface of the energy cell.

2. The energy cell holding device as claimed in claim 1, wherein the cutout and the overhang fix the energy cell to the contact plate via the casing surface of the energy cell by form fit and/or force fit and/or substance bonding all around the casing surface.

3. The energy cell holding device as claimed in claim 2, wherein at least one of the cutout or the overhang fixes the energy cell by form fit and force fit in a press-fit process.

4. The energy cell holding device as claimed in claim 2, wherein at least one of the cutout or the overhang fixes the energy cell by bonding with a glue, a solder, or a weld.

5. The energy cell holding device as claimed in claim 1, wherein the cutout and the overhang contact the casing surface of the energy cell inside a half-side region of the energy cell and make a contact on the end face of the energy cell inside the half-side region.

6. The energy cell holding device as claimed in claim 1, wherein the contact plate comprises an isolating layer to protect the energy cell holding device against corrosion.

7. A cell module structure for a motor vehicle, the cell structure comprising:
an energy cell; and
an energy cell holding device comprising a contact plate having a cutout and an overhang;
wherein the cutout and the overhang fix the energy cell to the contact plate via a casing surface of the energy cell by form fit and/or force fit and/or substance bonding; and
wherein the cutout and the overhang contact an electrical terminal of the energy cell via the casing surface of the energy cell.

8. The cell module structure as claimed in claim 7, wherein the energy cell has a cylindrical form or a round cell form.

9. The cell module structure as claimed in claim 7, wherein the energy cell comprises:
a contact on an end face of the energy cell as a first electrical contact; and
a contact on a casing surface as a second electrical contact;
wherein the second electrical contact is arranged inside a half-side region and the first electrical contact is arranged inside the half-side region.

10. The cell module structure as claimed in claim 7, wherein a casing surface of the energy cell is fixed to a contact plate of the energy cell holding device by form fit and/or force fit and/or substance bonding.
